(19) United States
(12) Patent Application Publication
(10) Pub. No.: US 2006/0112028 A1
(43) Pub. Date: May 25, 2006

(54) Neural Network and Method of Training

(76) Inventors: Weimin Xiao, Hoffman Estates, IL (US); Thomas M. Tirpak, Glenview, IL (US)

Correspondence Address: MOTOROLA, INC., 1303 EAST ALGONQUIN ROAD, IL01/3RD, SCHAUMBURG, IL, 60196, US

(21) Appl. No.: 10/711,191

(22) Filed: Nov. 24, 2004

(51) Int. Cl. G06N 3/02

(52) U.S. Cl. 706/15

(57) ABSTRACT

Methods of training neural networks (100, 600) that include one or more inputs (102-108) and a sequence of processing nodes (110, 112, 114, 116) in which each processing node may be coupled to one or more processing nodes that are closer to an output node are provided. The methods include establishing an objective function that preferably includes a term related to differences between actual and expected output for training data, and a term related to the number of weights of significant magnitude. Training involves optimizing the objective function in terms of weights that characterize directed edges of the neural network. The objective function is optimized using algorithms that employ derivatives of the objective function. Algorithms for accurately and efficiently estimating derivatives of the summed input going into output processing nodes of the neural network with respect to the weights of the neural network are provided.

### FIELD OF THE INVENTION

The present invention relates to neural networks.

### DESCRIPTION OF RELATED ART

The proliferation of computers accompanied by exponential increases in their processing power has had a significant impact on society in the last thirty years.

Commercially available computers are, with few exceptions, of the Von Neumann type. Von Neumann type computers include a memory and a processor. In operation, instructions and data are read from the memory and executed by the processor. Von Neumann type computers are suitable for performing tasks that can be expressed in terms of sequences of logical or arithmetic steps. Generally, Von Neumann type computers are serial in nature; however, if a function to be performed can be expressed in the form of a parallel algorithm, a Von Neumann type computer that includes a number of processors working cooperatively in parallel can be utilized.

For certain classes of problems, algorithmic approaches suitable for implementation on a Von Neumann machine have not been developed. For other classes of problems, although algorithmic approaches to the solution have been conceived, it is expected that executing the conceived algorithm would take an unacceptably long period of time.

Inspired by information gleaned from the field of neurophysiology, alternative means of computing and otherwise processing information known as neural networks were developed. Neural networks generally include one or more inputs, and one or more outputs, and one or more processing nodes intervening between the inputs and outputs. The foregoing are coupled by signal paths (directed edges) characterized by weights. Neural networks that include a plurality of inputs and that are aptly described as parallel due to the fact that they operate simultaneously on information received at the plurality of inputs have also been developed. Neural networks hold the promise of being able handle tasks that are characterized by a high input data bandwidth. In as much as the operations performed by each processing node are relatively simple and are predetermined, there is the potential to develop very high speed processing nodes and from them high speed and high input data bandwidth neural networks.

There is generally no overarching theory of neural networks that can be applied to design neural networks to perform a particular task. Designing a neural network involves specifying the number and arrangement of nodes, and the weights that characterize the interconnection between nodes. A variety of stochastic methods have been used in order to explore the space of parameters that characterize a neural network design in order to find suitable choices of parameters, that lead to satisfactory performance of the neural network. For example, genetic algorithms and simulated annealing have been applied to the design neural networks. The success of such techniques is varied, and they are also computationally intensive.

### BRIEF DESCRIPTION OF THE FIGURES

The present invention will be described by way of exemplary embodiments, but not limitations, illustrated in the accompanying drawings in which like references denote similar elements, and in which:

FIG. 1 is a graph representation of a neural network according to a first embodiment of the invention;

FIG. 2 is a block diagram of a processing node used in the neural network shown in FIG. 1;

FIG. 3 is a table of weights that characterize directed edges from inputs to processing nodes and between processing nodes in a hypothetical neural network of the type shown in FIG. 1;

FIG. 4 is a table of weights showing how a topology of the type shown in FIG. 1 can be transformed into a three-layer perceptron by zeroing selected weights;

FIG. 5 is a table of weights showing how a topology of the type shown in FIG. 1 can be transformed into a multi-output, multi-layer perceptron by zeroing selected weights;

FIG. 6 is a graph representing the topology reflected in FIG. 5;

FIG. 7 is a flow chart of a method of training the neural networks of the types shown in FIGS. 1, 6 according to the preferred embodiment of the invention;

FIG. 8 shows several subgraphs illustrating that the number of signal paths between two nodes is dependent on the number nodes which separate the two nodes;

FIG. 9 shows several subgraphs illustrating particular signal paths between two nodes that are considered in evaluating a linear approximation of the derivative of an output from a network with respect to a particular weight;

FIG. 10 is a table of randomly generated weights describing a network of the type shown in FIG. 10, that is used to evaluate the accuracy of linear estimates of derivatives of an output with respect to particular weights;

FIG. 11 is a table of derivatives calculated using the randomly generated weights shown in FIG. 10;

FIG. 12 is a table of highly accurate, low computation cost estimates of the derivatives shown in FIG. 11;

FIG. 13 is a flow chart of a method of selecting the number of nodes in neural networks of the types shown in FIGS. 1, 6 according to the preferred embodiment of the invention; and

FIG. 14 is a block diagram of a computer used to execute the algorithms shown in FIGS. 7, 13 according to the preferred embodiment of the invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

FIG. 1 is a graph representation of a feed forward neural network 100 according to a first embodiment of the invention. The neural network 100 includes a first input 102, a second input 104, a third input 106 and a fourth input 108. The inputs 102-108 can be referred to as input nodes. A fixed bias signal, e.g., input value 1.0, is applied to the first input 102. The neural network 100 further comprises a first processing node 110, a second processing node 112, a third processing node 114, and a fourth processing node 116. The fourth processing node 116 includes an output 118 that serves as a first output of the output of the neural network. A second output 128 of the neural network 100 is tapped from an output of the third processing node 114. The first two processing nodes 110, 112 are hidden nodes in as much as they do not directly supply output externally. Initially, at the outset of training at least, each of the inputs 102, 104, 106, 108 is preferably considered to be coupled by directed edges (e.g., 120, 122) to each of the processing nodes 110, 112, 114, 116. Also, initially at least, every processing node except the last 116 is preferably considered to be coupled by directed edges (e.g. 124, 126) to processing nodes that are downstream (closer to the fourth processing node 116). The direction of the directed edges is such that signals always pass from lower numbered processing nodes to higher numbered processing nodes (e.g., from the first processing node 110, to the third processing node 114). For a feed forward neural network of the type shown in FIG. 1 that has n inputs, and m processing nodes there are up to:

$$K = ( n + 1 ) m + \frac{1}{2} m ( m - 1 ) \qquad EQU . 1$$

directed edges each of which is characterized by a weight.

In Equation One, n+1 is the number of signal inputs, and m is the number of processing nodes. Note that n is the number of signal inputs other than the fixed bias signal input 102.

A characteristic of the feed forward network topology illustrated in FIG. 1 is that a signal can be coupled from one of a pair of nodes to a second of the pair of nodes, and both of the same pair of nodes can receive signals from a third node. For example, with reference to FIG. 1 the first processing node 110, is coupled to the second 112 and third 114 processing nodes by directed edges, and the second 112 and third 114 processing nodes are also coupled by a directed edge. This characteristic distinguishes the generalized neural network illustrated in FIG. 1, from a perceptron in which nodes are arranged in layers and do not receive signals from other nodes in the same layers. Note, however that a perceptron is a special case of the generalized neural network that can be obtained by selectively eliminating certain directed edges.

Neural networks of the type shown in FIG. 1 can for example be used in control applications where the inputs 104, 106, 108 are coupled to a plurality of sensors, and the outputs 118, 128 are coupled to output transducers.

In an electrical hardware implementation of the invention, the directed edges (e.g., 120, 122) are suitably embodied as attenuating and/or amplifying circuits. The processing nodes 110, 112, 114, 116 receive the bias signal and input signals from the four inputs 102-108. The bias signal and the input signals are multiplied by weights associated with directed edges through which they are coupled.

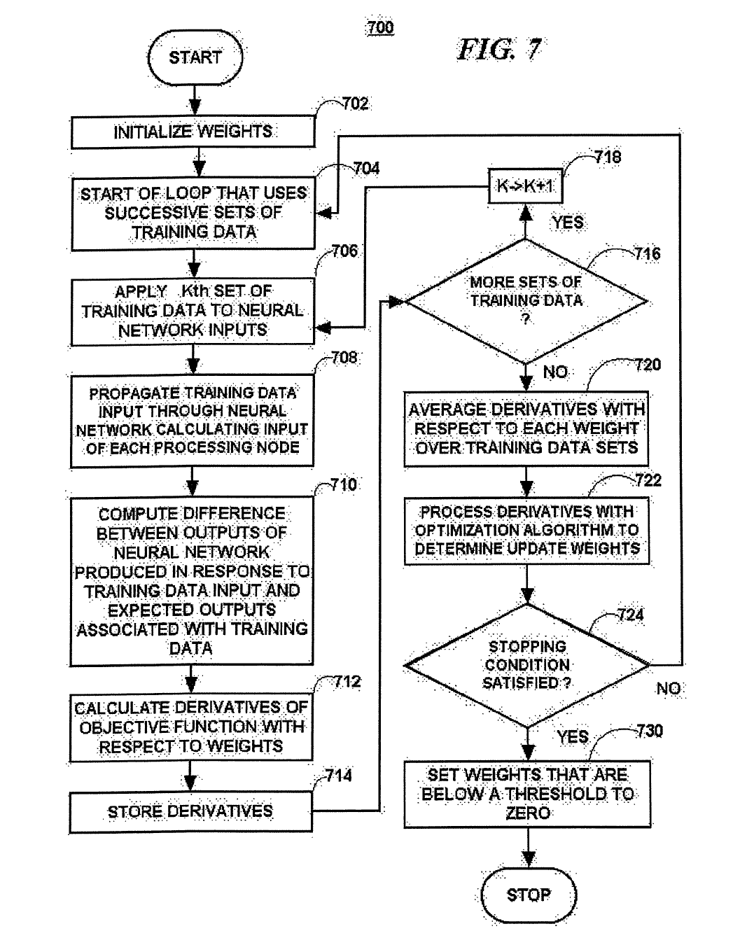

The neural network 100 is trained to perform a desired function. Training is akin to programming a Von Neumann computer in that training adapts the neural network 100 to perform a desired function. In as much as signal processing that is performed by the processing nodes 110-116 is preferably unaltered in the course of training the neural network 100 training is achieved by properly selecting the weights that are associated with the plurality of directed edges of the neural network. Training is discussed in detail below with reference to FIG. 7.

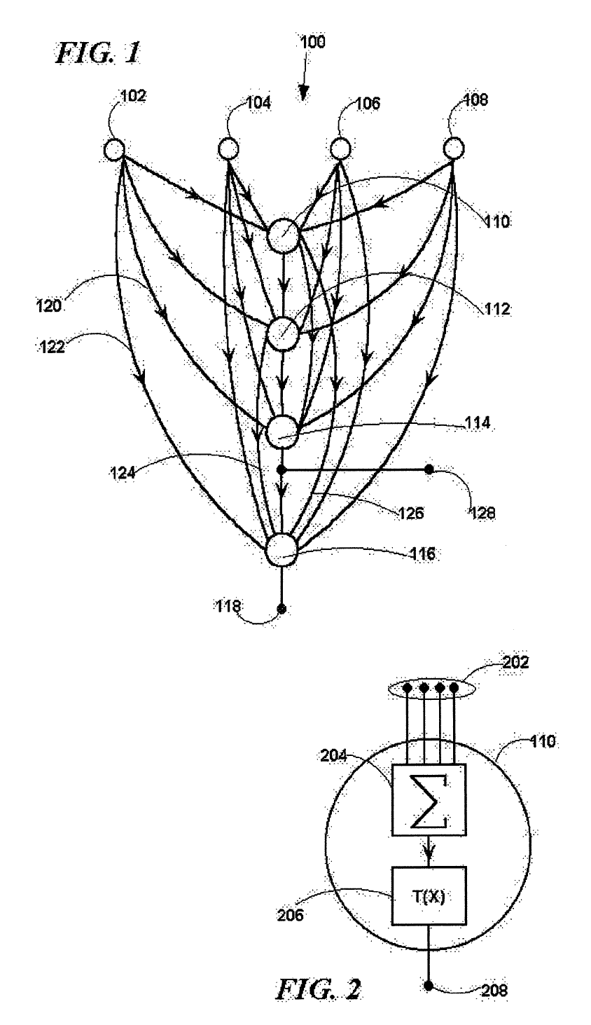

FIG. 2 is a block diagram of the first processing node 110 of the neural network 100 shown in FIG. 1. The first processing node 110 includes four inputs 202 that serve as inputs of a summer 204. In the case of the first processing node the inputs 202 receive signals directly from the inputs 102, 104, 106, 108 of the neural network 100. The summer 204 outputs a sum signal to transfer function block 206. The transfer function block 206 applies a transfer function to the sum signal and outputs a result as the processing node's output at an output 208. The transfer function is preferably the sigmoid function:

$${h}_{j} = \frac{1}{1 + {ⅇ}^{- {H}_{j}}} \qquad EQU . 2$$

where, hⱼ is the output of the transfer function block 206, and the output of a jth processing node e.g., processing node 110; and
Hⱼ is the summed input of a jth processing node e.g., the output of the summer 204.

The output 208 is coupled through a plurality of directed edges to the second 112, third 114, and fourth 116 processing nodes.

For classification problems, the expected output of the neural network 100 is chosen from a finite set of values e.g., one or zero, which respectively specify that a given set of inputs does or does not belong to a certain class. In classification problems, it is appropriate to use signals that are output by a threshold type (e.g., sigmoid) transfer function at the processing nodes that are used as outputs. The sigmoid function is aptly described as a threshold function in that it rapidly swings from a value near zero to a value near 1 near the domain value of zero. On the other hand, for regression type problems it is preferred to take the output at processing nodes that serve as outputs of a neural network of the type shown in FIG. 1 from the output of summers within those output processing nodes, and not process the final output signals by the sigmoid functions in the output processing nodes. This is appropriate because for regression problems the output is generally expected to be continuous as opposed to consisting of a finite set of discrete values.

Alternatively, in lieu of the sigmoid function other functions or approximations of the sigmoid or other functions are used as the transfer function that is performed by the transfer function block 206. For example, the Gaussian function is alternatively used in lieu of the sigmoid function.

The other processing nodes 112, 114, 116 preferably have the same design as shown in FIG. 2, with the exception that the other processing nodes include summers with different numbers of inputs in order to accommodate input signals from the neural network inputs 102-108 and from other processing nodes. In a hardware implementation of the neural network, the first processing nodes and other processing nodes are implemented in digital or analog circuitry or a combination thereof.

As will be discussed below, in the interest of providing less complex neural networks, according to embodiments of the invention some of the possible directed edges (as counted by Equation One) are eliminated. A method of selecting which directed edges to eliminate in order to provide a less complex and costly neural network is described below with reference to FIG. 7.

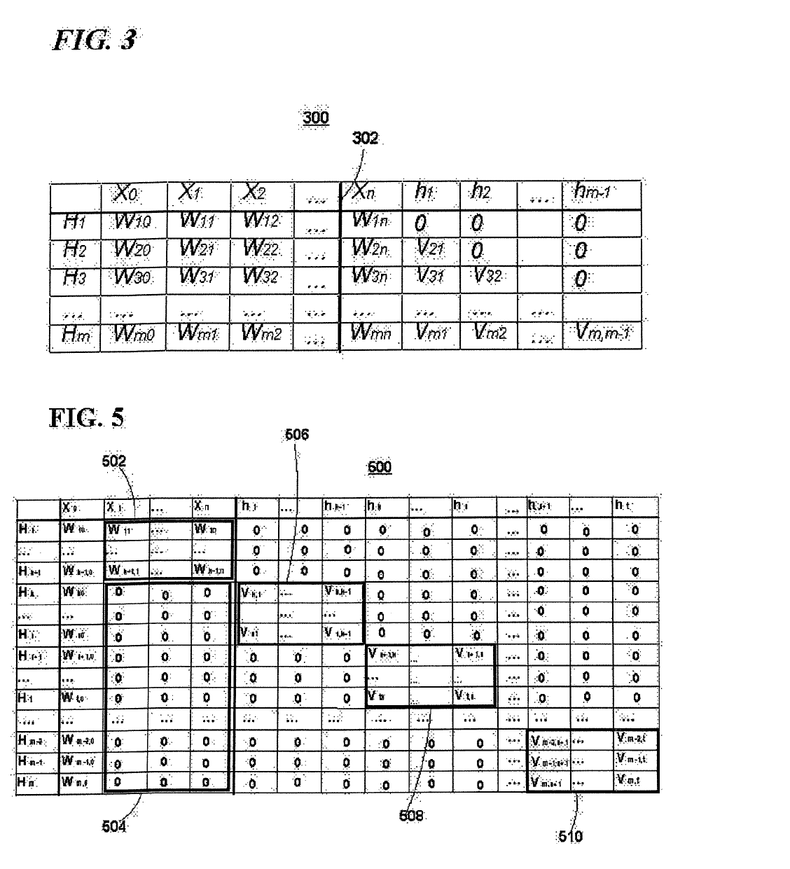

FIG. 3 is a table 300 of weights that characterize directed edges from inputs to processing nodes and between processing nodes in a hypothetical neural network of the type shown in FIG. 1. The first column of the table 300 identifies inputs of processing nodes. The subscripted capital H's appearing in the first column stand for the output of the summer in a processing node identified by the subscript.

The left side of the first row of table 300 (to the left of line 302) identifies inputs of the neural network. The left side of the first row includes subscripted X's where the subscript identifies a particular input. For example in the case of the neural network shown in FIG. 1 the neural network inputs 102, 104, 106, 108 would be identified in the left side of the first row as X₀, X₁, X₂, and X₃. The first input identified by X₀ is the input for the fixed bias (e.g., 102, in neural network 100). The entries in the left hand side of the table 300 which appear as double subscripted capital W's represent weights that characterize directed edges that couple the neural network's inputs to the neural network's processing nodes. The first subscript of each of the capital W's identifies a processing node at which a directed edge characterized by the weight symbolized by the subscripted W terminates, and the second subscript identifies a neural network input at which the directed edge characterized by the weight symbolized by the subscripted W originates.

The right side of the first row identifies outputs of each, except for the last, processing node by a subscripted lower case h. The subscript of on each lower case h identifies a particular processing node. The entries in the right side of the table 300 are double-subscripted capital V's. The subscripted capital V's represent weights that characterize directed edges that couple processing nodes of the neural network. The first subscript of each V identifies a processing node at which the directed edge that is characterized by the weight symbolized by the V in question terminates, whereas the second subscript identifies a processing node at which the directed edge characterized by the weight symbolized by the V in question originates.

All the weights in each row have the same first subscript, which is equal to the subscript of the capital H in the same row of the first column of the table, which identifies a processing node at which the directed edges characterized by the weights in the row terminate. Similarly, weights in each column of the table have the same second index that identifies an input (on the left hand side of the table 300) or a processing node (on the right hand side of the table) at which the directed edges characterized by the weights in each column originate. Note that the right side of table 300 has a lower triangular form. The latter aspect reflects the feed forward only character of neural networks according to embodiments of the invention.

Table 300 thus concisely summarizes important information that characterizes a neural network.

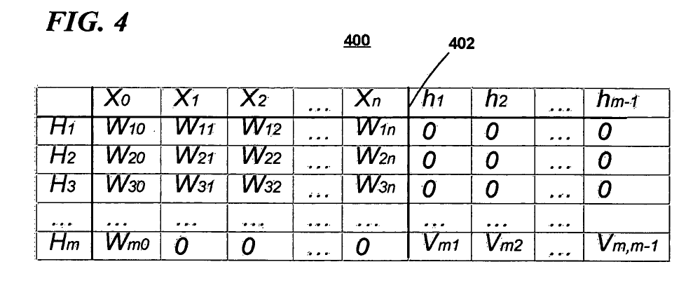

FIG. 4 is a table 400 of weights showing how a topology of the type shown in FIG. 1 can be transformed into a three-layer perceptron by zeroing out selected weights. As reflected on the left hand side (to the left of heavy line 402) a plurality of processing nodes up to an (m−1)th processing node (shown explicitly for the first three processing nodes) are coupled to a number n of neural network inputs. The first neural network input labeled X₀ serves as a fixed bias signal input. As reflected on the right hand side of the table 400 there is no inter-coupling between the processing nodes (1^{st} to (m−1)th) that are coupled to the inputs. This is represented by zero entries for the weights that characterize directed edges between those processing nodes. The first m−1 processing nodes effectively serve as a hidden layer of a single hidden layer perceptron. As indicated by entries in the right side of the last row of the table, the processing nodes m to m−1 that are directly coupled to the signal inputs X₁ to Xₙ are coupled to an mth processing node that serves as an output of the neural network. Thus by eliminating certain directed edges of a feed forward network of the type shown in FIG. 1, such a feed forward network can be transformed into a perceptron having a plurality of processing nodes organized in a single hidden layer. Additional output processing nodes that are coupled to the first m−1 processing nodes can also be added to obtain a plural output single hidden layer perceptron.

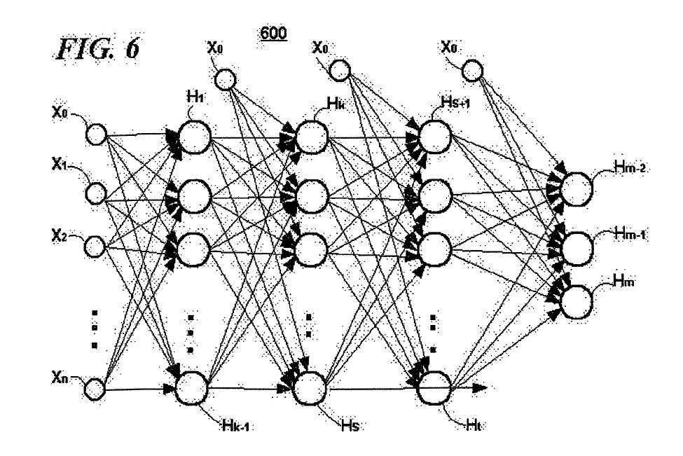

FIG. 5 is a table 500 of weights showing how a topology of the type shown in FIG. 1 can be transformed into a multi-output, multi-hidden-layer perceptron by zeroing out selected weights and FIG. 6 is a graph of a neural network 600 representing the topology reflected in FIG. 5. The table 500 reflects that the neural network 600 has n inputs labeled X₀ to Xₙ. The first input denoted X₀ is preferably used as a fixed bias signal input. (Note that the same X₀ appears in several places in FIG. 6) The neural network 600 further comprises m processing nodes labeled 1 to m. The column for the first, fixed bias signal input X₀ includes weights that act as scaling factors for the biases applied to the m processing nodes. A first block section 502 of the table 500 reflects that the signal inputs X₁-X_{N} are coupled to the first k−1 processing nodes. A second block section 504 reflects that the signal inputs X₁-X_{N} are not coupled to the remaining m−k+1 processing nodes of the neural network 600.

A third block section 506 reflects that outputs of the first k−1 processing nodes (that are coupled to the inputs X₁-X_{N}) are coupled to inputs of next s−k+1 processing nodes that are label by subscripts ranging from k to s. Zeros above the third block 506 indicate that in this example there is no intercoupling among the first k−1 processing nodes, and that the neural network is a feed forward network. Zeros below the third block 506 indicate that no additional processing nodes receive signals from the first k−1 processing nodes.

Similarly, a fourth block 508 reflects that a successive set of t-s processing nodes labeled s+1 to t receives signals from processing nodes labeled k to s. Zeros above the fourth block 508 reflect the feed forward nature of the neural network 600, and that there is no inter-coupling between the processing nodes labeled k to s. The zeros below the fourth block 508 reflect that no further processing nodes beyond those labeled s+1 to t receive signals from the processing nodes labeled k to s.

A fifth block 510 reflects that a set of processing nodes labeled m−2 to m, that serve as outputs of the neural network 600 described by the table 500, receive signals from processing nodes labeled s+1 to t. Zeros above the fifth processing block 510 reflect the feed forward nature of the network 600, and that no processing nodes other than those labeled m−2 to m receive signals from processing nodes labeled s+1 to t.

Thus, the table 500 illustrates that by selectively eliminating directed edges (tantamount to zeroing associated weights) a neural network of the type illustrated in FIG. 1, but having a greater number of processing nodes, can be transformed into the multi-input, multiple hidden layer perceptron shown in FIG. 6. In the case illustrated in FIGS. 5-6, processing nodes 1 to k−1 serve as a first hidden layer, processing nodes k to s serve as a second hidden layer, and nodes s+1 to t serve as a third hidden layer.

In neural networks of the type shown in FIG. 1, the summed input Hₖ to a kth processing node is given by:

$${H}_{k} = {\sum }_{i = 0}^{n} {W}_{ki} {X}_{i} + {\sum }_{j = 1}^{k - 1} {V}_{kj} {h}_{j} \qquad EQU . 3$$

where, Xᵢ is an ith input that is coupled to the kth processing node;
Wₖᵢ is a weight that characterizes a directed edge from the ith input to the kth processing node;
hⱼ is the output of a jth processing node that is coupled to the kth processing node; and
Vₖⱼ is a weight that characterizes a directed edge from the jth processing node to the kth processing node.

The output of the kth processing node is then given by Equation Two. Thus by repeated application of Equations Two and Three a specified input vector [X₀ . . . Xₙ] can be propagated through a neural network of the type shown in FIG. 1 (and variations thereof obtained by selectively zeroing weights) and the output of such a neural network at one or more output processing nodes can be calculated.

FIG. 7 is a flow chart of a method 700 of training neural networks of the general type shown in FIG. 1 according to the preferred embodiment of the invention. Although the method 700 is preferably performed using a computer model of a neural network, the results found using the method, can then be applied to a hardware implemented neural network.

Referring to FIG. 7, in block 702 weights that characterize directed edges of the neural network to be trained are initialized. The weights can for example be initialized randomly, initialized to some predetermined number (e.g., one), or initialized to some values entered by the user (e.g., based on experience or guesses).

Block 704 is the start of a loop that uses successive sets of training data. The training data preferably includes a plurality of sets of training data that represent the domain of input that the neural network to be trained is expected to process. Each kth training data set preferably includes a vector of inputs Xₖ=[X₀ . . . Xₙ]ₖ and an associated expected output Yₖ or a vector of expected outputs Yₖ=[Ym-q . . . Ym]ₖ in the case of a multi-output neural network.

In block 706 the input vector of the a kth set of training data is applied to the neural network being trained, and in block 708 the input vector of the kth set of training data is propagated through the neural network. Equations Two and Three are used to propagate the training data input through the neural network being trained. In executing block 708 the output of each processing node is determined and stored, at least temporarily, so that such output can be used later in calculating derivatives as described below.

In step 710 the difference between the output of the neural network produced by the kth vector of training data inputs, and the associated expected output for the kth training data is computed. In the case of single output neural network regression the difference is given by:
ΔRₖ=Hₘ(W,V,Xₖ)−Yₖ EQU. 4

where ΔRₖ is the difference between the output produced in response the kth training data input vector Xₖ, and the expected output Yₖ that is associated with the input vector X_{k.}; Hₘ(W,V,Xₖ) is the output (at an mth processing node) of the neural network produced in response to the kth training data input vector Xₖ. The bold face W represent the set of weights that characterize directed edges from the neural network inputs to the processing nodes; and the bold face V represents the set of weight that characterized directed edges that couple processing nodes. Hₘ is a function of W, V and Xₖ. As mentioned above for regression problems a threshold transfer function such as the sigmoid function is not applied at the processing nodes that serve as outputs. Therefore, for regression problems the output Hₘ is equal to the summed input of the mth processing node which serves as an output of the neural network being trained.

As described more fully below, in the case of a multi-output neural network the difference between actual output produced by the kth training data input, and the expected output is computed for each output of the neural network.

In block 712 the derivatives with respect to each of the weights in the neural network, of a kth term (corresponding to the kth set of training data) of an objective function being used to train the neural network are computed. Optimizing, and preferably, in particular minimizing, the objective function in terms of the weights is tantamount to training the neural network. In the case of a single output neural network the square of the difference given by Equation Four is preferably used in the objective function to be minimized. For a single output neural network the objective function is preferably given by:

$$OBJ = \frac{1}{2 N} {\sum }_{k = 1}^{N} {( {H}_{m} ( W , V , {X}_{k} ) - {Y}_{k} )}^{2} \qquad EQU . 5$$

where the summation index k specifies a training data set; and

N is the number of training data sets.

Alternatively, a different function of the difference is used as the objective function. The derivative of the kth term of the objective function given by Equation Five with respect to a weight of a directed edge coupling a th input of the neural network to an jth processing node of the neural network is:

$$\frac{\partial OBJ}{\partial {W}_{ji}} {\vert}_{k} = Δ {R}_{k} \frac{\partial {H}_{m}}{\partial {W}_{ji}} \qquad EQU . 6$$

The derivative on the right hand side of Equation Six which is the derivative of the summed input Hₘ at the mth processing node (which is the output node of the neural network) with respect to the weight Wⱼᵢ of the neural network is unfortunately, for certain values of i,j, a rather complicated expression. This is due to the fact that the directed edge that is characterized by weight Wⱼᵢ may be remote from the output (mₜₕ) node, and consequently a change in the value of Wⱼᵢ can cause changes in the strength of signals reaching the mth processing node through many different signal paths (each including a series of one or more directed edges).

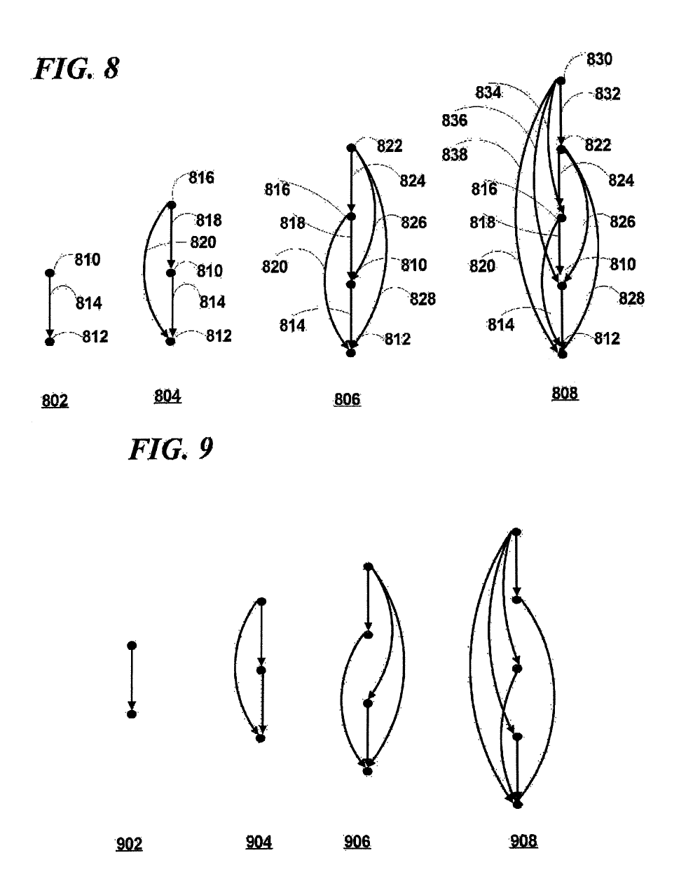

FIG. 8 shows four subgraphs including a first subgraph 802 that has two nodes, a second subgraph 804 that has three nodes, a third subgraph 806 that has four nodes, and a fourth subgraph 808 that has five nodes. The four subgraphs 802, 804, 806, 808 taken together illustrate the dependence of the number of different paths between two nodes on the number of nodes by which the two nodes are separated. The first subgraph 802 includes a first node 810 and a second node 812 that are connected together by a single (first) directed edge 814 which constitutes a single path.

Each successive subgraph (with the subgraphs 802-808 taken from left to right) can be understood as including a preceding subgraph (to its left) as a subgraph. As indicated by common reference numerals 810-814, the second subgraph 804 includes the first subgraph 802 as a subgraph. The second subgraph 804 also includes an additional, third node 816, a second directed edge 818, and a third directed edge 820. The second directed edge 818 connects the third node 816 to the first node 810 thereby accessing the single path of the first subgraph 802 which is a subgraph in the second subgraph 804. The third directed edge 820 couples the third node 816 directly to the second node 812 thereby providing an additional signal path. Thus, in the second subgraph 804 there is one signal path inherited from the first subgraph 802, and the path through the third directed edge 820 for a total of two paths between third node 816 and the second node 812.

As indicated again by common reference numerals the third subgraph 806 includes the second subgraph 804 as a subgraph. The third subgraph 806 includes an additional, fourth node 822, a fourth directed edge 824, a fifth directed edge 826, and a sixth directed edge 828. The fourth directed edge 824 connects the fourth node 822 to the third node 816, at which signal flow in the second subgraph 804 (here a subgraph) commences. Thus, the fourth directed edge 824 accesses the two signal paths of the second subgraph 804. The fifth directed edge 826 connects the fourth node 822 to the first node 810 at which signal flow in the first subgraph 802 (here a subgraph) commences, thus the fifth directed edge 826 provides access to an additional signal path. Finally, the sixth directed edge 828 provides a new signal path from the fourth node 822 directly to the second node 812, at which signal flow terminates in the third subgraph 806. Thus in the third subgraph 806 there are a total of 2+1+1=4 signal paths between the fourth node 822 and the second node 822, which are separated by two interceding nodes in the third subgraph 806.

As indicated once more by common reference numerals the fourth subgraph 808 includes the third subgraph 806 as a subgraph. The fourth subgraph 808 also includes a fifth node 830, a seventh directed edge 832, an eighth directed edge 834, a ninth directed edge 836, and a tenth directed edge 838. The seventh directed edge 832 connects the fifth node 830 to the fourth node 822 at which signal flow for the third subgraph 806 (here a subgraph) commences, thereby accessing the four signal paths of the third subgraph 806. Similarly, the eighth directed edge 834 connects the fifth node 830 directly to the third node 816, thereby providing separate access to the two signal paths of the second subgraph 804. The ninth directed edge 836 connects the fifth node 830 to the first node 810 thereby accessing the single signal path of the first subgraph 802. The tenth directed edge 838 directly connects the fifth node 830 to the second node 812 providing a separate signal path. Thus the number of signal paths between the fifth node 830 and the second node 812 is the sum of the signal paths from the first subgraph 802 (=1), the second subgraph 804 (=2), and the third subgraph 806 (=4), plus one for the tenth directed edge 838, which equals eight.

The five nodes 810, 812, 814, 816, 822, 830 have been enumerated in the order that they were introduced in the discussion above. However, according to the usual convention, the nodes are assigned successive integers proceeding in the direction of signal propagation, as is done in connection with FIG. 1 for the processing nodes 110-116. Based on the pattern of dependence of the number of signal paths on the number of nodes in the subgraph that is manifested in the four subgraphs 802-808 of FIG. 8, a general rule that relates the number of signal paths between two nodes to the separation between the two nodes can be deduced. Given the aforementioned conventional enumeration, the rule is expressed as:
SP=2^{m-k-1} 7
where SP is the number of signal paths;
m is the integer index of a signal sink node; and
k is the integer index of a signal source node.

To fully take into account the effect of signals propagating through all paths, on the derivatives in the right hand side of Equation Six, these derivatives can be evaluated for various values of i, j using the following generalized procedure expressed in pseudo code.

First Output Derivative Procedure:

$$If j == m , \\ \frac{\partial {H}_{m}}{\partial {W}_{mi}} = {X}_{i}$$

$$Otherwise , \\ {w}_{j} = {X}_{i} \frac{ⅆ {T}_{j}}{ⅆ {H}_{j}}$$

$$\frac{\partial {H}_{m}}{\partial {W}_{ji}} = {V}_{mj} {w}_{j}$$

$$For ( r = j + 1 ; r < m ; r ++ )$$

$$\{ \\ {w}_{r} = \frac{ⅆ {T}_{r}}{ⅆ {H}_{r}} {\sum }_{t = j}^{r - 1} {V}_{rt} {w}_{t \\} \\ \frac{\partial {H}_{m}}{\partial {W}_{ji}} += {V}_{mr} {w}_{r} \\ \}$$

In the first output derivative procedure
dTᵣ/dHᵣ is the derivative of the transfer function of an rth processing node treating the summed input Hᵣ as an independent variable;
dTⱼ/dHⱼ is the derivative of the transfer function of a jth processing node treating the summed input Hⱼ as an independent variable; and
wⱼ and wᵣ are temporary variables, used for holding incremental calculations.

The latter two derivatives dTᵣ/dHᵣ, dTⱼ/dHⱼ, are evaluated at the values of Hⱼ and Hᵣ that occur when a specific training data set (e.g., the kth) is propagated through the neural network being trained.

The sigmoid function given by Equation Two above has the property that its derivative is simply given by:

$$\frac{ⅆ {T}_{j}}{ⅆ {H}_{j}} = {h}_{j} ( 1 - {h}_{j} ) \qquad EQU . 8$$

where hⱼ is the output of a jth processing node that uses the sigmoid transfer function; and
Hⱼ is the summed input of the ith processing node.

Therefore, in the case that the sigmoid function is used as the transfer function in processing nodes, the derivatives of the transfer function appearing in the first output derivative procedure are preferably replaced by the form given by Equation Eight. As mentioned above the output of each processing node (e.g., hⱼ) is determined and stored when training data is propagated through the neural network in step 708, and is thus available for use in the case that Equation Eight is used in the first derivative output procedure (or in the second derivative output procedure described below). In the alternative case of a transfer function other than the sigmoid function, in which the derivatives of transfer function are expressed in terms of the independent variable (input to transfer function), it is appropriate when propagating training data through the neural network, in block 708, to determine and store, at least temporarily, the summed input to each processing node, so that such input can be used in evaluating derivatives of processing nodes transfer functions in the course of executing the first output derivative procedure.

Although the working of the first output derivative procedure is more concisely and effectively communicated via the pseudo code shown above than can be communicated in words, a description of the procedure is as follows. In the special case that the weight under consideration connects to the output under consideration (i.e., if j=m), then the derivative of the summed input Hₘ with respect to the weight Wⱼᵢ is simply set to the value of the ith input Xᵢ, because the contribution to Hₘ that is due to the input Wⱼᵢ is simply the product of Xᵢ and Wⱼᵢ.

In the more complicated and more common case in which the directed edge characterized by the weight Wⱼᵢ under consideration is not directly connected to the output (mth) node under consideration the procedure works as follows. First, an initial contribution to the derivative being calculated that is related to a weight Vₘⱼ is computed. The weight Vₘⱼ characterizes a directed edge that connects the jth processing node at which the directed edge characterized by the weight Wⱼᵢ with respect to which the derivative is being take terminates, to the mth output, the derivative of the summed input of which, is to be calculated. The initial contribution includes a first factor that is the product of the derivative of the transfer function of the jth node at which the weight Wⱼᵢ terminates (evaluated at its operating point given a set of training data), and the input Xᵢ at the ith input, at which the directed edge characterized by the weight Wⱼᵢ originates, and a second factor that is the weight Vₘⱼ. The first factor which is aptly termed a leading part of the initial contribution is stored and will be used subsequently. The initial contribution is a summand which will be added to as described below.

After the initial contribution has been computed, the for loop in the pseudo code listed above is entered. The for loop considers successive rth processing nodes, starting with the (j+1)th node that immediately follows the jth node at which the directed edge characterized by the Wⱼᵢ weight with respect to which the derivative being taken terminates, and ending at the (m−1) node immediately preceding the output (mth) node under consideration, the summed input of which the derivative being taken is of. At each rth node another rth summand-contribution to the derivative is computed. The contribution of each ith processing node in the range j+1 to m−1 includes a leading part that is the product of the derivative of the transfer function of the node in question (rth) at its operating point, and what shall be called an rth intermediate sum. The rth intermediate sum includes a term for each tth processing node from the jth processing node up to the (r−1)th node that precedes the rth processing node for which the intermediate sum is being evaluated. For each rth node of the aforementioned sequence of nodes jth to (r−1)th the summand of the rth intermediate sum is a product of a weight characterizing a directed edge from the tth processing node to the rth processing node, and the value of the leading part that has been calculated during a previous iteration of the for loop for the tth processing node (or in the case of the jth node calculated before entering the for loop). The leading parts can thus be said to be calculated in a recursive manner in the first output derivative procedure. Furthermore, in the each rth summand contribution to the overall derivative being calculated, the aforementioned leading part for the rth node, and a weight that characterizes a directed edge from the rth node to the mth processing node are multiplied together.

The first output derivative procedure could be evaluated symbolically for any values of j, i, and m for example by using a computer algebra application such as Mathematica, published by Wolfram Research of Champaign, Ill. in order to present a single closed form expression. However, in as much as numerous sub-expressions (i.e., the above mentioned leading parts) would appear repetitively in such an expression, it is more computationally efficient and therefore preferable to evaluate the derivatives given by the first output derivative procedure using a program that is closely patterned after the pseudo code representation.

The derivative of the kth term of the objective function given by Equation Five with respect to a weight V_{dc} of a directed edge coupling the output of a cth processing node to the input of a dth processing node is:

$$\frac{\partial OBJ}{\partial {V}_{dc}} {\vert}_{k} = Δ {R}_{k} \frac{\partial {H}_{m}}{\partial {V}_{dc}} \qquad EQU . 9$$

The derivative on the right side of Equation Nine is the derivative of the summed input an mth processing node that serves as an output of the neural network with respect to a weight that characterizes the directed edge that couples the cth processing node to the dth processing node. This derivative can be evaluated using the following generalized procedure expressed in pseudo code:

Second Output Derivative Procedure:

$$If d == m , \\ \frac{\partial {H}_{m}}{\partial {V}_{mc}} = {h}_{c}$$

$$Otherwise , \\ {v}_{d} = {h}_{c} \frac{ⅆ {T}_{d}}{ⅆ {H}_{d}}$$

$$\frac{\partial {H}_{m}}{\partial {V}_{dc}} = {V}_{md} {v}_{d}$$

$$For ( r = d + 1 ; r < m ; r ++ )$$

$$\{ \\ {v}_{r} = \frac{ⅆ {T}_{r}}{ⅆ {H}_{r}} {\sum }_{t = d}^{r - 1} {V}_{rt} {v}_{t} \\ \frac{\partial {H}_{m}}{\partial {V}_{dc}} += {V}_{mr} {v}_{r} \\ \}$$

The second output derivative procedure is analogous to the first output derivative procedure. In the preferred case that the transfer function of processing nodes in the neural network is the sigmoid function, in accordance with Equation Eight, dTᵣ/dHᵣ is replaced by hᵣ(1−hᵣ), and dT_{d}/dH_{d} is replaced by h_{d}(1−h_{d}). vᵣ and v_{d} are temporary variables. The exact nature of second output derivative procedure is also evident by inspection. The second output derivative procedure functions in a manner analogous to the first output derivative procedure.

Although the exact nature of the second derivative output procedure is, as in the case of the first derivative procedure, best ascertained by examining the pseudo code presented above, the operations can be described as follows: In the special case that the weight under consideration characterizes a directed edge that connects to the output under consideration (i.e., if d=m), then the derivative of the summed input Hₘ with respect to the weight V_{dc} is simply set to the value of the output h_{c} of the cth processing node at which the directed edge characterized by the weight V_{dc} with respect to which the derivative being calculated originates, because the contribution to Hₘ that is due to the input V_{dc} is simply the product of V_{dc} and h_{c}.

In the more complicated and more common case in which the directed edge characterized by the weight under consideration is not directly connected to the mth output under consideration the procedure works as follows. First, an initial contribution to the derivative being calculated that is due to a weight V_{md} is computed. The weight V_{md} characterizes a directed edge that connects the dth processing node at which the directed edge characterized by the weight V_{dc} with respect to which the derivative is being take, terminates, to the mth output the derivative of the summed input of which is to be calculated. The initial contribution includes a first factor that is the product of the derivative of the transfer function of the dth node at which the weight V_{dc} terminates (evaluated at its operating point given a set of training data input), and the output h_{c} at the cth processing node, at which the directed edge characterized by the weight V_{dc} originates, and a second factor that is the weight V_{md} that characterizes a directed edge between the dth and mth nodes. The first factor which is aptly termed a leading part of the initial contribution is stored and will be used subsequently. The initial contribution is a summand which will be added to as described below.

After the initial contribution has been computed, the for loop in the pseudo code listed above is entered. The operation of the for loop in the second output derivative procedure is analogous to the operation of the for loop in the first output derivative procedure that is described above.

Equation Seven which enumerates the number of paths between two nodes in a generalized feed forward neural network suggests that the computational cost of evaluating the derivatives in the right hand sides of Equations Six and Nine would be proportional to two raised to the power of one less than the difference between an index (m) identifying a node at which output is taken and an index (j or d) which identifies a node at which a directed edge characterized by the weight with respect to which the derivative is taken terminates. However, by using the first and second output derivative procedures, in which the leading parts are saved and reused, the computation cost of calculating the derivatives in the right hand sides of Equations Six and Nine is reduced to:

$$CC ∝ \frac{1}{2} n ( n + 1 ) \qquad EQU . 10$$

where, CC is the computational cost; and
n is equal to the difference m−k of the indices defined in the context of Equation Seven.

For certain applications, it is desirable to provide a large number of processing nodes. Although, using the first and second derivative output procedures reduces the computational cost of evaluating derivatives, even if these are used the computational cost rises rapidly as the number of processing nodes is increased.

A highly accurate, method of estimating the derivatives appearing in the right hand sides of Equation Six and Nine has been determined. This method has a lower computational cost than the first and second output derivative procedures. In fact, the computational cost is linear in n, the variable appearing in Equation Ten. An analysis that elucidates why the estimation method is as accurate as it is, is given below as an introduction to the method.

Consider a feed forward neural network in which the transfer function of each node is the sigmoid function. The derivative of a summed input Hₘ to an m^{th} output node with respect to a weight characterizing a directed edge from an j^{th} node to a k^{th} node includes a term that is based on signal flow along a path that passes through each node between the kth node and the mth node. This term is given by the following product:

$${V}_{m , m - 1} {\overline{h}}_{m - 1} \cdot {V}_{m - 1 , m - 2} {\overline{h}}_{m - 2} \cdot … \cdot {V}_{k + 1 , k} {\overline{h}}_{k} \frac{\partial {H}_{k}}{\partial {W}_{ki}} = ( {\prod }_{r = k}^{m - 1} {V}_{r + 1 , r} ) ( {\prod }_{r = k}^{m - 1} {\overline{h}}_{r} ) \cdot \frac{\partial {H}_{k}}{\partial {W}_{ki}} \qquad EQU . 11$$

Equation Eleven
\overline{hₓ}
is the value of the derivative of the transfer function of an x^{th} node.
In the right hand side of Equation Eleven, the product of weights of directed edges along the path have been collected, and the product of the derivatives of the transfer functions encountered along the path have been collected. It is of consequence that the derivative of the sigmoid transfer function takes on a maximum value of 0.25. (The exact value of 0.25 is obtained when the independent variable is equal to zero). The maximum value of the derivative the sigmoid transfer function determines an upper bound on the term of the derivative given in Equation Eleven that is expressed as:

$$EQU . 12 \text{:}$$

$$\vert ( {\prod }_{r = k}^{m - 1} {V}_{r + 1 , r} ) ( {\prod }_{r = k}^{m - 1} {\overline{h}}_{r} ) \cdot \frac{\partial {H}_{k}}{\partial {W}_{ki}} \vert \leq \frac{1}{{4}^{m - k}} \vert ( {\prod }_{r = k}^{m - 1} {V}_{r + 1 , r} ) \frac{\partial {H}_{k}}{\partial {W}_{ki}} \vert$$

It has been observed that most directed edge weights in a well trained feed forward neural network of the type shown in FIG. 1 are in the range (0,1). Based on this it is reasonable to assume that the remaining product in the right hand side of Equation Twelve is less than one. Accordingly, the upper bound on the derivative term shown in Equation Eleven can be rewritten as:

$$\vert ( {\prod }_{r = k}^{m - 1} {V}_{r + 1 , r} ) ( {\prod }_{r = k}^{m - 1} {\overline{h}}_{r} ) \cdot \frac{\partial {H}_{k}}{\partial {W}_{ki}} \vert \leq \frac{1}{{4}^{m - k}} \vert \frac{\partial {H}_{k}}{\partial {W}_{ki}} \vert \qquad EQU . 13$$

Equation Thirteen demonstrates that the contribution of a path from a directed edge characterized by a weight with respect to which the derivative is being taken, to the derivative in question decreases by at least 75% for each additional directed edge along the path. In other words, paths that include many directed edges contribute little to the derivative in question.

The preceding arguments, presented with reference to Equations 11-13 provide an ex post facto explanation of why derivative estimation procedures described below are as accurate as they are.

A first derivative estimation procedure that can be used to estimated the derivative of an input Hₘ to an m^{th} output node with respect to a weight Wₖᵢ characterizing a directed edge from an j^{th} input to a k^{th} node is expressed in pseudo code as:

First Derivative Estimation Procedure

$$If k == m , \frac{\partial {H}_{m}}{\partial {W}_{mi}} = {X}_{i}$$

$$Otherwise , \\ {w}_{k} = {X}_{i} \frac{ⅆ {T}_{k}}{ⅆ {H}_{k}}$$

$$\frac{\partial {H}_{m}}{\partial {W}_{ki}} = {V}_{mk} {w}_{k}$$

$$For ( r = k + 1 ; r < m ; r ++ )$$

$$\{ \\ \frac{\partial {H}_{m}}{\partial {W}_{ki}} += {V}_{mr} {V}_{rk} \frac{ⅆ {T}_{r}}{ⅆ {H}_{r}} {w}_{k} \\ \}$$

Although, the exact nature of the first derivative estimation procedure is best ascertained by examining the pseudo code representation given above, the first derivative estimation procedure can be described in words as follows. First in the special case that the directed edge, characterized by the weight with respect to which the derivative is being taken, terminates at the output node, the input of which is being differentiated the derivative being estimated is simply set equal to the value Xᵢ of the input at the jth input node at which the directed edge characterized by the weight with respect to which the derivative is being taken, originates. In this special case the procedure gives the exact value of the derivative.

In the more general case, a leading part denoted wₖ which is the product of a signal Xᵢ emanating from the i^{th} node at which the directed edge characterized by the weight with respect to which the derivative is being taken originates and the transfer function of a k^{th} node at which the directed edge characterized by the weight with respect to which the derivative is being taken terminates is computed. Next an initial contribution to the derivative being estimated which is the product of the leading part and a weight of a directed edge from the k^{th} node to the m^{th} output node is calculated. The initial contribution is a summand to which a summand for each node between the k^{th} node and the m^{th} node is added. For each r^{th} node between the k^{th} node and the m^{th} node a summand that is the product of a weight of a directed edge from the k^{th} node to the r^{th} node, a weight of a directed edge from the r^{th} node to the m^{th} node, a transfer function of the r^{th} node, and the leading part denoted wₖ is added. Note that each of these summands for each r^{th} node involves a path that includes only two directed edges.

Similar to the first derivative estimation procedure, a second derivative estimation procedure that can be used to estimated the derivative of an input Hₘ to an m^{th} output node with respect to a weight V_{cd} characterizing a directed edge from a c^{th} processing node to a d^{th} node is expressed in pseudo code as:

Second Derivative Estimation Procedure

$$If d == m , \\ \frac{\partial {H}_{m}}{\partial {V}_{mc}} = {h}_{c}$$

$$Otherwise , \\ {v}_{d} = {h}_{c} \frac{ⅆ {T}_{d}}{ⅆ {H}_{d}}$$

$$\frac{\partial {H}_{m}}{\partial {V}_{dc}} = {V}_{md} {v}_{d}$$

$$For ( r = d + 1 ; r < m ; r ++ )$$

$$\{ \\ \frac{\partial {H}_{m}}{\partial {V}_{dc}} += {V}_{mr} {V}_{rd} \frac{ⅆ {T}_{r}}{ⅆ {H}_{r}} {v}_{d} \\ \}$$

The second derivative estimation procedure is the same as the first derivative estimation procedure, with the exception that the input Xᵢ is replaced by the output hᵢ of the j^{th} node at which the directed edge, that is characterized by the weight with respect to which the derivative being evaluated is taken, originates.

The first and second derivative estimation procedures only consider paths that have at most two directed edges between a node at which a directed edge characterized by the weight with respect to which a derivative being taken terminates and an output node. Other paths that are made up of more directed edges are ignored. Nonetheless, the first and second derivative estimation procedures give very accurate estimates.

In the case that the transfer function of processing nodes in the neural network is the sigmoid function, the form of the derivative of the sigmoid transfer function given in Equation Eight is suitably used in the first and second derivative estimation procedures.

FIG. 9 illustrates four subgraphs including a first subgraph 902 that has two nodes, a second subgraph 904 that has three nodes, a third subgraph 906 that has four nodes and a fourth subgraph 908 that has five nodes. These subgraphs are similar to the four subgraphs shown in FIG. 8. However, the subgraphs shown in FIG. 9 include only those directed edges that are involved in paths that are considered in the first and second derivative estimation procedures, in the case that a derivative of a summed input to the bottom node of each subgraph with respected to a weight characterizing a directed edge that terminates at the top node in each subgraph is being estimated. Note that only paths that involve one or two directed edges are shown in FIG. 9.

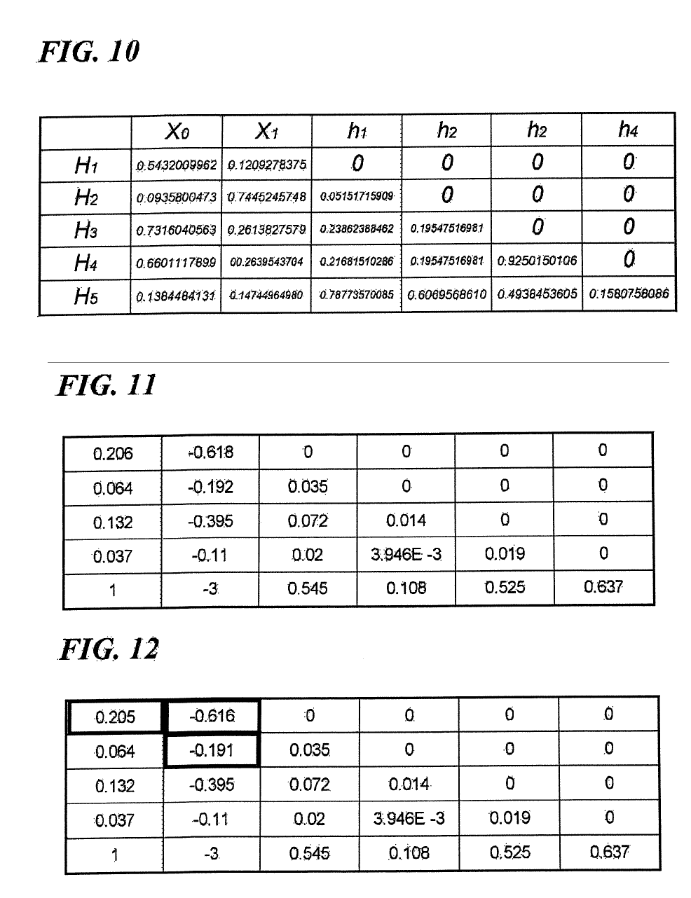

To demonstrate the accuracy of the first and second derivative estimation procedures a numerical experiment was performed. The numerical experiment involved a neural network of the type shown in FIG. 1 that had two inputs, (one of which would be used to input a bias signal), five processing nodes and one output. The output was taken from the output of the summer of the fifth processing node. Weights characterizing the directed edges in the neural networks were selected using a random number generator. The randomly generated weights are shown in FIG. 10. The arrangement of FIG. 10 is the same as that of FIG. 3, described above. A bias of value of 1 and an input value of −3 were assumed. The derivative of the output with respect to each weight was then calculated using the first and second output derivative procedures, and then recalculated using the first and second derivative estimation procedures. The results obtained using the first and second output derivative procedures are shown in FIG. 11. The results obtained using the first and second derivative estimation procedure are shown in FIG. 12. In FIGS. 10, 11 the derivatives are arranged in the same arrangement as the weights are arranged in FIG. 10. As is evident in FIGS. 10-11 the results only differ in the third significant figure for three derivatives that are affected by the approximation.

Thus, in calculating the derivatives in block 712 of the process shown in FIG. 7, either the first and second output derivative procedures or the first and second derivative estimation procedures are alternatively used. The lower computational cost of he first and second derivative estimation procedures would weigh in favor of using them as the number of nodes of a neural network is increased.

Referring again to FIG. 7, in step 714 the derivatives calculated in the preceding step 712 are stored. The next block 716 is a decision block the outcome depends on whether there are more sets of training data to be processed. If affirmative then in block 718 a counter that points to successive training data sets is incremented, and thereafter the process 700 returns to block 706. Thus, blocks 706 to 714 are repeated for a plurality of sets of training data. If in block 716 it is determined that all of the training data sets have been processed, then the method 700 continues with block 720 in which the derivatives with respect to each weight are averaged over the training data sets. The average over N training data sets of the derivative of the objective function with respect to the weight characterizing a directed edge from an ith input to a jth processing node is given by:

$$AVG ( \frac{\partial OBJ}{\partial {W}_{ji}} ) = \frac{1}{N} {\sum }_{k = 1}^{N} Δ {R}_{k} \frac{\partial {H}_{m}}{\partial {W}_{ji}} \qquad EQU . 14$$

Similarly, the average over N training data sets of the derivative of the objective function with respect to the weight characterizing a directed edge form cth processing node to dth processing node is given by:

$$AVG ( \frac{\partial OBJ}{\partial {V}_{dc}} ) = \frac{1}{N} {\sum }_{k = 1}^{N} Δ {R}_{k} \frac{\partial {H}_{m}}{\partial {V}_{dc}} \qquad EQU . 15$$

Note that the derivatives ∂Hₘ/∂Wⱼᵢ, ∂Hₘ/∂V_{dc} in the right hand sides of Equations Fourteen and Fifteen must be evaluated separately for each kth set of training data, because they are dependent on the operating point of the transfer function block (e.g. 206) in each processing node which is dependent on the training data applied to the neural network.

In step 722 the average of the derivatives of the objective function that are computed in step block 720 are processed with an optimization algorithm in order to calculate new values of the weights. Depending on how the objective function to be optimized is set up, the optimization algorithm seeks to minimize or maximize the objective function. The objective function given in Equation Five and other objective functions shown herein below are set up to be minimized. A number of different optimization algorithms that use derivative evaluation including, but not limited to, the steepest descent method, the conjugate gradient method, or the Broyden-Fletcher-Goldfarb-Shanno method are suitable for use in block 722. Suitable routines for use in step 722 are available commercially and from public domain sources. Suitable routines that implement one or more of the above mentioned methods or other suitable gradient based methods are available from the Netlib a World Wide Web accessible repository of algorithms, and commercially from, for example, Visual Numerics of San Ramon, Calif. Algorithms that are appropriate for step 722 are described, for example, in chapter 10 of the book “Numerical Recipes in Fortran” edited by William H. Press, and published by the Cambridge University Press and in chapter 17 of the book “Numerical Methods That Work” authored by Forman S. Acton, and published by Harper & Row. Although the intricacies of nonlinear optimizations routines are outside of the focus of the present description, an outline of the application of the steepest descent method is described below. Optimization routines that are structured for reverse communication are advantageously used in step 722. In using an optimization routine that uses reverse communication, the optimization routine is called (i.e., by a routine that embodies method 700) with values of derivatives of a function to be optimized.

In the case that the steepest descent method is used in step 722, a new value of the weight that characterizes the directed edge from the ith input to the jth processing node is given by:

$${W}_{ji}^{new} = {W}_{ji}^{old} - α AVG ( \frac{\partial OBJ}{\partial {W}_{ji}} ) \qquad EQU . 16$$

where, α is a step length control parameter.

Also using the steepest descent method a new value of the weight that characterizes the directed edge from the cth processing node to the dth processing node is given by:

$${V}_{dc}^{new} = {V}_{dc}^{old} - β AVG ( \frac{\partial OBJ}{\partial {V}_{dc}} ) \qquad EQU . 17$$

where β is a step length control parameter.

The step length control parameters are often determined by the optimization routine employed, although in some cases the user may effect the choice by an input parameter.

Although, as described above, new weights are calculated using derivatives of the objective function that are averaged over all N training data sets, alternatively new weights are calculated using averages over less than all of the training data sets. For example, one alternative is to calculate new weights based on the derivatives of the objective function for each training data set separately. In the latter embodiment it is preferred to cycle through the available training data calculating new weight values based on each training data set.

Block 724 is a decision block the outcome of which depends on whether a stopping condition is satisfied. The stopping condition preferably requires that the difference between the value of the objective function evaluated with the new weights and the value of the objective function calculated with the old weights is less than a predetermined small number, that the Euclidean distance between the new and the old processing node to processing node weights is less than a predetermined small number, and that the Euclidean distance between the new and old input-to-processing node weights is less than a predetermined small value. Expressed in mathematical notation the preceding conditions are:
|OBJ^{NEW}−OBJ^{OLD}|<ε₁ EQU. 18
∥W^{OLD}−W^{NEW}∥<ε₂ EQU. 19
∥V^{OLD}−V^{NEW}∥<ε₃ EQU. 20

W^{NEW}, W^{OLD} are collections of the weights that characterize directed edges between inputs and processing nodes that were returned by the last call and the call preceding the last call of the optimization algorithm respectively.

V^{NEW}, V^{OLD} are collections of the weights that characterize directed edges between processing nodes that were returned by the last call and the call preceding the last call of the optimization algorithm respectively. The collections of weights are suitably arranged in the form of a vector for the purpose of finding the Euclidean distances.

OBJ^{NEW} and OBJ^{OLD} are the values of the objective function e.g., Equation Five for the current and preceding values of the weights.

The predetermined small values used in the inequalities Eighteen through Twenty can be the same value. For some optimization routines the predetermined small values are default values that can be overridden by a call parameter.

If the stopping condition is not satisfied, then the process 700 loops back to block 704 and continues from there to update the weights again as described above. If on the other hand the stopping condition is satisfied then the process 700 continues with block 730 in which weights that are below a certain threshold are set to zero. For a sufficiently small threshold, setting weights that are below that threshold to zero has a negligible effect on the performance of the neural network. An appropriate value for the threshold used in step 730 can be found by routine experimentation, e.g., by trying different values and judging the effect on the performance of one or more neural networks. If certain weights are set to zero the directed edges with which they are associated need not be provided. Eliminating directed edges simplifies the neural network and thereby reduces the complexity and semiconductor die space required for hardware implementations of the neural network. Alternatively, step 730 is eliminated. After process 700 has finished or after process 800 (described below) has been completed if the latter is used, the final values of the weights are used to construct a neural network. The neural network that is constructed using the weights can be a software implemented neural network that is for example executed on a Von Neumann computer; however, it is alternatively a hardware implemented neural network. The weights found by the training process 700 are built into an actual neural network that is to be used in processing input data and producing output.

Method 700 has been described above with reference to a single output neural network. Method 700 is alternatively adapted to training a multi-output neural network of the type illustrated in FIG. 1. For multi-output neural networks that are used for regression or other problems with continuous outputs, in lieu of the objective function of Equation Five, an objective function of the following form is preferred:

$$OBJ = \frac{1}{2 MP} {\sum }_{t = 1}^{P} {\sum }_{k = 1}^{M} {( {H}_{t} ( W , V , {X}_{k} ) - {Y}_{kt} )}^{2} \qquad EQU . 21$$

where the summation index k specifies a particular set of training data;
the summation index t specifies a particular output;
P is the number of output processing nodes;
M is the number of training data sets;
Hₜ(W,V, Xₖ) is the output (equal to the summed input) at a tth processing node when a kth vector of training data input is applied to the neural network; and

Yₖₜ, is the expected output value for the tth processing node that is associated with the kth set of training data.

Equation Twenty-One is particularly applicable to neural networks for multi-output regression problems. As noted above for regression problems it is preferred not to apply a threshold transfer function such as the sigmoid function at processing nodes that serve as the outputs. Therefore, the output at each tth output processing node is preferably simply the summed input to that tth output processing node.

Equation Twenty-One averages the difference between actual outputs produced in response a training data and the expected outputs associated with the training data. The average is taken over the multiple outputs of the neural network, and over multiple training data sets.

The derivative of the latter objective function with respect to a weight of the neural network is given by:

$$\frac{\partial OBJ}{\partial {w}_{i}} = \frac{1}{MP} {\sum }_{k = 1}^{M} ( {\sum }_{t = 1}^{P} ( {H}_{t} ( W , V , {X}_{k} ) - {Y}_{kt} ) \frac{\partial {H}_{t}}{\partial {w}_{i}} ) \qquad EQU . 22$$

where wᵢ stands for either a weight characterizing input-to-processing node directed edges, or directed edges that couple processing nodes.
(Note that because Hₜ is a function of k, the derivative ∂Hₜ/∂wᵢ must be evaluated for each value of k separately.)

In the case of a multi-output neural network the weights are adjusted based on the effect of the weights on all of the outputs. In an adaptation of the process shown in FIG. 7 to a multi-output neural network derivatives of the form shown in Equation Twenty-Two, that are taken with respect to each of the weights in the neural network to be determined, are processed by an optimization algorithm in step 722.

In addition to the control application mentioned above, an application of multi-output neural networks of the type shown in FIG. 1, is to predict the high and low values that occur during a kth period of finite duration of stochastic times series data (e.g., stock market data) based on input high and low values for n preceding periods (k−n) to (k−1).

As mentioned above in classification problems it is appropriate to apply the sigmoid function at the output nodes. (Alternatively, other threshold functions are used in lieu of the sigmoid function.) Aside from the special case in which what is desired is a yes or no answer as to whether a particular input belongs to a particular class, it is appropriate to use a multi-output neural network of the type shown in FIG. 1 to solve classification problems.

In classification problems one way to represent an identification of a particular class for an input vector, is to assign each of a plurality of outputs of the neural network to a particular class. An ideal output for such a network, might be an output value of one at the neural network output that correctly corresponds to the class of an input vector, and output values of zero at each of the remaining neural network outputs. In practice, the class associated with the neural network output node at which the highest value is output in response to a given input vector is construed as the correct class for the input vector. In the alternative, the neural network is trained to output a low value (ideally zero) at an output corresponding to the correct class, and output values close to one (ideally one) at other outputs.

For multi-output classification neural networks an objective function of the following form is preferable:

$$R ( W , V ) = \frac{1}{2 MP} {\sum }_{k = 1}^{M} {\sum }_{t = 1}^{P} Δ {R}_{kt}^{2} \qquad EQU . 23$$

where, the t summation index specifies output nodes of the neural network;
the k summation index identifies a training data set with which actual and expected outputs are associated; and

$$Δ {R}_{kt} = \{ \begin{matrix}{h}_{t} ( W , V , {X}_{k} ) - {Y}_{kt} & for wrong classification \\ 0 & for correct classification\end{matrix} \qquad EQU . 24$$

where hₜ is the output of the a transfer function at a tth processing node that serves as an output of the neural network.

Equation Twenty-Four is applied as follows. For a given kth set of training data, in the case that the correct output of the neural network being trained has the highest value of all the outputs of the neural network (even though it is not necessarily equal to one), the output for that kth training data is treated as being completely correct and ΔR_{KT} is set to zero for all outputs from 1 to P. If the correct output does not have the highest value, then element by element differences are taken between the actual output produced in response to the kth training data input and expected output that is associated with the kth training data set.

Such a neural network is preferably trained with training data sets that include input vectors for each of the classes that are to be identified by the neural network.

The derivative of the objective function given in Equation Twenty-Three with respect to an Ah weight of the neural network is:

$$\frac{\partial OBJ}{\partial {w}_{i}} = \frac{1}{MP} {\sum }_{k = 1}^{M} ( {\sum }_{t = 1}^{P} Δ {R}_{kt} \frac{ⅆ {T}_{t}}{ⅆ {H}_{t}} \frac{\partial {H}_{t}}{\partial {w}_{i}} ) \qquad EQU . 25$$

where dT/dHₜ is the derivative of the transfer function of the tth processing node with respect to the summed input Hₜ. of the tth processing node (with the summed input treated as an independent variable)

In the preferred case that the transfer function is the sigmoid function the derivative dhₜ/dHₜ can be expressed as hₜ(1−ht) where hₜ is the value of the sigmoid function for summed input Hₜ. In an adaptation of the process shown in FIG. 7 to a multi-output neural network used for classification, derivatives of the form shown in Equation Twenty-Five, that are taken with respect to each of the weights in the neural network to be determined, are processed by the optimization algorithm in step 722.

It is desirable to reduce the number of directed edges in neural networks of the type shown in FIG. 1. Among the benefits of reducing the number of directed edges is a reduction in complexity, and power dissipation of hardware implemented embodiments. Furthermore, neural networks with fewer interconnections are less prone to over-training. Because it has learned the specific data but not their underlying structure, an over-trained network performs well with training data but not with other data of the same type to which it is applied subsequent to training. According to further embodiments of the invention described below, a cost term that is dependent on the number of weights of significant magnitude is included in an objective function used in training with an aim of reducing the number of weights of significant magnitude. A predetermined scale factor is used to judge the size of weights. Recall that in step 730 discussed above, directed edges characterized by weights that are below a predetermined threshold are preferably excluded from implemented neural networks. Using an objective function that tends to reduce the number of weights of significant magnitude in combination with step 730 tends to reduce the complexity of neural networks produced by the training method 700.

Preferably the aforementioned cost term is a continuously differentiable function of the magnitude of weights so that it can be included in an objective function that is optimized using optimization algorithms, such as those mentioned above, that require derivative information.

A preferred continuously differentiable expression of the number of near zero weights in a neural network is:

$$U = {\sum }_{i = 1}^{K} {ⅇ}^{η {w}_{i}^{2}} \qquad EQU . 26$$

where wᵢ is an ith weight of the neural network; and
η is a scale factor relative to which the magnitude of weights are judged.
η is preferably chosen such that if a weight is equal to the threshold used in step 730 below which weights are set to zero, the value of the summand in Equation Twenty-One is preferably at least 0.5.

The summation in Equation Twenty-Six preferably includes all the weights of the neural network that are to be determined in training. Alternatively, the summation is taken over a subset of the weights.

The expression of near-zero weights is suitably normalized by dividing by the total number of possible weights for a network of the type shown in FIG. 1 which number is given by Equation One above. The normalized expression of the number of near zero weights is given by:

$$F = \frac{U}{K} \qquad EQU . 27$$

F can take on values in the range from zero to one. F or other measures of near zero weights are preferably included in an objective function along with a measure of the differences between actual and expected output values. In order that F can have a significant impact in reducing the number of weights of significant value, it is desirable that the value and the derivative of F is not insubstantial compared with the measure of the differences between actual and expected output values. One preferred way to address this goal is to use the following measure of differences between actual and expected values of:

$$L = \frac{{R}_{N}}{{R}_{O} + {R}_{N}} \qquad EQU . 28$$
where R_{N} is a measure of the differences between actual and expected values during a current iteration of the training algorithm; and
R_{O} is a value of the measure of differences between actual and expected values for an iteration of the training algorithm preceding the current iteration.

According to the above definition, L also takes on values in the range from zero to one. The measure of differences used in Equation Twenty-Eight is preferably the sum of the squares of differences between actual output produced by training data, and expected output values associated with training data.

An objective function that combines the normalized expression of the number of near zero weights and the measure of the differences between actual and expected values is:
OBJ=(1−λ)L−λF EQU. 29
in which, λ is a user chosen parameter that determines the relative priority of the sub-objective of minimizing the differences between actual and expected values, and the sub-objective of minimizing the number of weights of significant value. Lambda is preferably chosen in the range of 0.01 to 0.1, and is more preferably approximately equal to 0.05. Too high a value of lambda can lead to reduction of the complexity of the neural network at the expense of its prediction or classification performance, whereas too low of a value can lead to a network that is excessively complex and in some cases prone to over training. Note that the normalized expression of the number of near zero weights F (Equation Twenty-Seven) appears with a negative sign in the objective function given in Equation Twenty-Nine, so that F serves as a term of the cost function that is dependent on the number of weights of significant value.

The derivative of the expression of the number of near zero weights given Equation Twenty-Seven with respect to an ith weight wᵢ is:

$$\frac{\partial F}{\partial {w}_{i}} = - \frac{2 η}{K} {w}_{i} {ⅇ}^{- η {w}_{i}^{2}} \qquad EQU . 30$$

and the derivative of the measure of differences between actual and expected values given by Equation Twenty-Eight with respect to an ith weight wᵢ is:

$$\frac{\partial L}{\partial {w}_{i}} = \frac{{R}_{O}}{{( {R}_{O} + {R}_{N} )}^{2}} \frac{\partial {R}_{N}}{\partial {w}_{i}} \qquad EQU . 31$$

In evaluating the latter derivative, R_{O} is treated as a constant.

Adapting the form of the measure of differences between actual and expected values given in Equation Five (i.e., the average of squares of differences) and taking the derivative with respect to the ith weight wᵢ the following derivative of the objective function of Equation Twenty-Nine is obtained:

$$\begin{matrix}\frac{\partial OBJ}{\partial {w}_{i}} = ( 1 - λ ) \frac{{R}_{O}}{{( {R}_{O} + {R}_{N} )}^{2}} \frac{1}{N} {\sum }_{q = 1}^{N} ( {H}_{m} ( W , V , {X}_{q} ) - {Y}_{q} ) \frac{\partial {H}_{m}}{\partial {w}_{i}} + \frac{2 λη}{K} {w}_{i} {ⅇ}^{- η {w}_{i}^{2}} \\ where , & EQU . 32 \\ {R}_{N} = \frac{1}{2 N} {\sum }_{k = 1}^{N} {( {H}_{m} ( W , V , {X}_{k} ) - {Y}_{k} )}^{2} & EQU . 33\end{matrix}$$

the summation index q specifies one of N training data sets.

Similarly, by adapting the form of the measure of differences between actual and expected values given in Equation Twenty-One, which is appropriate for multi-output neural networks used for regression problems, and taking the derivative with respect to an ith weight wᵢ the following derivative of the objective function of Equation Twenty-Nine is obtained:

$$\begin{matrix}\frac{\partial OBJ}{\partial {w}_{i}} = ( 1 - λ ) \frac{{R}_{O}}{{( {R}_{O} + {R}_{N} )}^{2}} \frac{1}{MP} {\sum }_{q = 1}^{M} ( {\sum }_{t = 1}^{P} ( {h}_{t} ( W , V , {X}_{q} ) - {Y}_{q t} ) \frac{\partial {H}_{t}}{\partial {w}_{i}} ) + \frac{2 λ η}{K} {w}_{i} {ⅇ}^{- η {w}_{i}^{2}} \\ where , & EQU . 34 \\ {R}_{N} = \frac{1}{2 MP} {\sum }_{q = 1}^{M} ( {\sum }_{t = 1}^{P} {( {h}_{t} ( W , V , {X}_{q} ) - {Y}_{q t} )}^{2} ) & EQU . 35\end{matrix}$$

the summation index q specifies one of M training data sets; and
the summation index t specifies one of P outputs of the neural network.

Also, by adapting the form of the measure of differences between actual and expected values given in Equation Twenty-Three, which is appropriate for multi-output neural networks used for classification problems, and taking the derivative with respect to an ith weight wᵢ the following derivative of the objective function of Equation Twenty-Nine is obtained:

$$\begin{matrix}\frac{\partial OBJ}{\partial {w}_{i}} = \frac{2 λ η}{K} {w}_{i} {ⅇ}^{- η {w}_{i}^{2}} + ( 1 - λ ) \frac{{R}_{O}}{{( {R}_{O} + {R}_{N} )}^{2}} \frac{1}{MP} {\sum }_{k = 1}^{M} {\sum }_{t = 1}^{P} [ ( {h}_{t} ( W , V , {X}_{k} ) - {Y}_{kt} ) \frac{ⅆ T}{ⅆ {H}_{t}} \frac{\partial {H}_{t}}{\partial {w}_{i}} ] \\ where , & EQU . 36 \\ {R}_{N} = \frac{1}{2 MP} {\sum }_{k = 1}^{M} {\sum }_{t = 1}^{P} {( {h}_{t} ( W , V , {X}_{k} ) - {Y}_{k t} )}^{2} & EQU . 37\end{matrix}$$

Note that in the Equations presented above hₜ stands for the output of the tth node's transfer function which is preferably but not necessarily the sigmoid function.

By optimizing the objective functions of which Equations Thirty-Two, Thirty-Four and Thirty-Six are the required derivatives, and thereafter setting weights below a certain threshold to zero, neural networks that perform well, are less complex and less prone to over training are generally obtained.

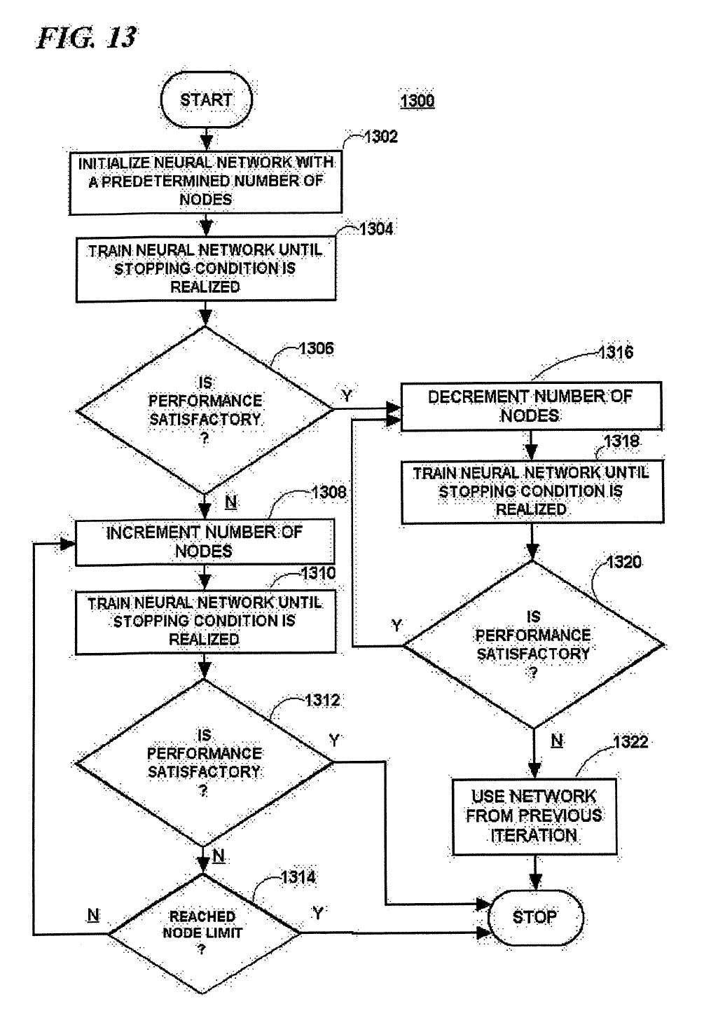

FIG. 13 is a flow chart of a process 1300 of selecting the number of nodes in neural networks of the types shown in FIGS. 1, 6 according to the preferred embodiment of the invention. The process 1300 shown in FIG. 3 seeks to find the minimum number of processing nodes required to achieve a prescribed accuracy. In block 1302 a neural network is set up with a number of nodes. The number of nodes can be a number selected at random or a number entered by a user based on the user's guess as to how many nodes might be required to solve the problem to be solved by the neural network. In block 1304 the neural network set up in block 1302 is trained until a stopping condition (e.g., the stopping condition described with reference to Equations Eighteen, Nineteen and Twenty) is realized. The training performed in block 1304 and in blocks 1310 and 1318 discussed below is preferably done according to the process shown in FIG. 7. Block 1306 is a decision block, the outcome of which depends on whether the performance of the neural network trained in step 1304 is satisfactory. The decision made in block 1306 (and those made in blocks 1312, and 1320 described below) is preferably an assessment of accuracy based on comparisons of actual output for training data, and expected output associated with the training data. For example, the comparison may be made based on the sum of the squares of differences.

If in block 1306 it is determined that performance of neural network is not satisfactory, then in order to try to improve the performance by adding additional processing nodes, the process 1300 continues with block 1308 in which the number of processing nodes is incremented. The topology of the type shown in FIG. 1 (i.e., a feed-forward sequence of processing nodes) is preferably maintained when incrementing the number of processing nodes. In block 1310 the neural network formed in the preceding block 1308 by incrementing the number of nodes is trained until the aforementioned stopping condition is met. Next, in block 1312 it is ascertained whether or not the performance of the augmented neural network that was formed in block 1308 is satisfactory. If the performance is now found to be satisfactory then the process 1300 halts. If on the other hand it is found that the performance is still not satisfactory, then the process 1300 continues with block 1314 in which it is determined if a prescribed node limit has been reached. The node limit is preferably a value set by the user. If it is determined that the node limit has been reached then the process 1300 halts. If on the other hand the node limit has not been reached then the process 1300 loops back to block 1308 in which the number of nodes is again incremented and the thereafter the process continues as described above until either satisfactory performance is attained or the node limit is reached.

If in block 1306 it is determined that the performance of the neural network is satisfactory, then in order to try to reduce the complexity of the neural network, the process 1300 continues with block 1316 in which the number of processing nodes of the neural network is decreased. As before, the type of topology shown in FIG. 1 is preferably maintained when reducing the number of processing nodes. Next in block 1318 the neural network formed in the preceding block 1316 by decrementing the number of nodes is trained until the aforementioned stopping condition is met. Next, in block 1320 it is determined if the performance of the network trained in block 1318 is satisfactory. If it is determined that the performance is satisfactory then the process 1300 loops back to block 1316 in which the number of nodes is again decremented and thereafter the process 1300 proceeds as described above. If on the other hand it is determined that the performance is not satisfactory, then the parameters (e.g., number of nodes, weights) of the last satisfactory neural network are saved in block 1322 and the process halts. Rather than halting, as described above, other blocks are alternatively added to the processes shown in FIG. 7 and FIG. 13.

By utilizing the process 1300 for finding the minimum number of nodes required to achieve a predetermined accuracy in combination with an objective function that includes a term intended to reduce the number of weights of significant magnitude, reduced complexity neural networks can be realized. Such reduce complexity neural networks can be implemented using less die space, dissipate less power, and are less prone to over-training.

The neural networks having sizes determined by process 1300 are implemented in software or hardware.

The processes depicted in FIGS. 7,13 are preferably embodied in the form of one or more programs that can be stored on a computer-readable medium which can be used to load the programs into a computer for execution. Programs embodying the invention or portions thereof may be stored on a variety of types of computer readable media including optical disks, hard disk drives, tapes, programmable read only memory chips. Network circuits may also serve temporarily as computer readable media from which programs taught by the present invention are read.

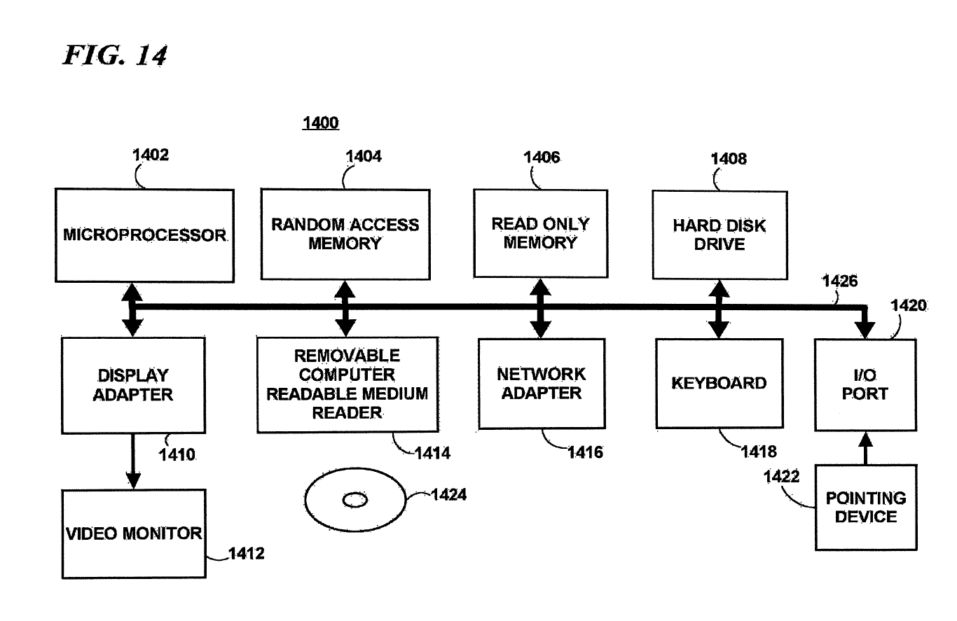

FIG. 14 is a block diagram of a computer 1400 used to execute the algorithms shown in FIGS. 7,13 according to the preferred embodiment of the invention. The computer 1400 comprises a microprocessor 1402, Random Access Memory (RAM) 1404, Read Only Memory (ROM) 1406, hard disk drive 1408, display adopter 1410, e.g., a video card, a removable computer readable medium reader 1414, a network adapter 1416, keyboard 1418, and I/O port 1420 communicatively coupled through a digital signal bus 1426. A video monitor 1412 is electrically coupled to the display adapter 1410 for receiving a video signal. A pointing device 1422, preferably a mouse, is electrically coupled to the I/O port 1420 for receiving electrical signals generated by user operation of the pointing device 1422. According to one embodiment of the invention, the network adapter 1416 is used, to communicatively couple the computer to an external source of training data, and/or programs embodying methods 700, 1300 such as a remote server. The computer readable medium reader 1414 preferably comprises a Compact Disk (CD) drive. A computer readable medium 1424 that includes software embodying the algorithms described above with reference to FIGS. 7,13 is provided. The software included on the computer readable medium is loaded through the removable computer readable medium reader 1414 in order to configure the computer 1400 to carry out processes of the current invention that are described above with reference to flow diagrams. The computer 1400 may for example comprise a personal computer or a workstation computer.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A neural network comprising:
a first node;
a second node adapted to receive and process signals from said first node;
a first directed edge between said first node and said second node for transmitting signals from said first node to said second node, wherein said first directed edge is characterized by a first weight;
an output node adapted to receive and process signals from said second node;
a second directed edge between said second node and said output node for transmitting signals from said second node to said output node, wherein said second directed edge is characterized by a second weight;
a plurality of additional nodes between said second node and said output node;
a first plurality of directed edges coupling said second node to said plurality of additional nodes;
a second plurality of directed edges coupling said plurality of additional nodes to said output node;
a third plurality of directed edges coupling signals from nodes among said plurality of additional nodes to other nodes among said plurality of additional nodes that are closer to said output node;
wherein, said first weight has a value that is determined by a process of training said neural network that comprises:
estimating a derivative of a summed input to said output node with respect to said first weight by:
multiplying a signal output by said first node by a value of a derivative of a transfer function of said second node that obtains when training data is applied to said neural network to obtain a first factor;
multiplying said first factor by said second weight to compute a first summand;
for each particular node of the plurality of additional nodes between said second node and said output node, computing an additional summand by multiplying together the first factor, a weight characterizing one of the first plurality of directed edges that couples the second node to the particular node, a weight characterizing one of the second plurality of directed edges that couples the particular node to the output node, and a value of a transfer function of the particular node; and
summing the first summand and the additional summands, wherein, in estimating said derivative, paths from said second node to said output node that involve said third plurality of directed edges are not considered.

2. The neural network according to claim 1 wherein said first directed edge, said second directed edge, said first plurality of directed edges and said second plurality of directed edges comprise one or more amplifying circuits.

3. The neural network according to claim 1 wherein said first directed edge, said second directed edge, said first plurality of directed edges, and said second plurality of directed edges comprise one or more attenuating circuits.

4. The neural network according to claim 1 wherein said first node comprises an input of said neural network.

5. The neural network according to claim 1 wherein said first node comprises a hidden processing node of said neural network.

6. The neural network according to claim 1 wherein:
said plurality of additional nodes include sigmoid transfer functions.

7. The neural network according to claim 1 wherein said process of training said neural network comprises:
(a) applying training data to said neural network, whereby said summed input is generated at said output node;
(b) computing a value of a derivative of an objective function that depends on said derivative of said summed input to said output node with respect to said first weight;
(c) processing said derivative of said objective function with an optimization algorithm that uses derivative information; and
(d) repeating (a)-(c) until a stopping condition is satisfied.

8. The neural network according to claim 7 wherein in said process of training said neural network, processing said derivative of said objective function comprises:
using a nonlinear optimization algorithm selected from the group consisting of the steepest descent method, the conjugate gradient method, and the Broyden-Fletcher-Goldfarb-Shanno method.

9. The neural network according to claim 7 wherein in said process of training said neural network:
(a)-(b) are repeated for a plurality of training data sets, and an average of said derivatives of said objective function over said plurality of training data sets is used in (c).

10. The neural network according to claim 7 wherein in said process of training said neural network:
after (d), setting weights that fall below a predetermined threshold to zero.

11. The neural network according to claim 10 wherein:
the objective function is a function of a difference an actual output of said neural network that depends on said summed input to said output node and an expected output; and
the objective function is a continuously differentiable function of a measure of near zero weights.

12. The neural network according to claim 11 wherein:
the measure of near zero weights takes the form:
$$U = {\sum }_{i = 1}^{K} {ⅇ}^{- η {w}_{i}^{2}}$$
where, Wᵢ is a an ith weight
K is a number of weights in the neural network;
T is a scale factor to which weights are compared.

13. A method of training a neural network that comprises:
a first node;
a second node adapted to receive and process signals from said first node;
a first directed edge between said first node and said second node for transmitting signals from said first node to said second node, wherein said first directed edge is characterized by a first weight;
an output node adapted to receive and process signals from said second node;
a second directed edge between said second node and said output node for transmitting signals from said second node to said output node, wherein said second directed edge is characterized by a second weight;
a plurality of additional nodes between said second node and said output node;
a first plurality of directed edges coupling said second node to said plurality of additional nodes;
a second plurality of directed edges coupling said plurality of additional nodes to said output node;
a third plurality of directed edges coupling signals from nodes among said plurality of additional nodes to other nodes among said plurality of additional nodes that are closer to said output node;
the method comprising:
estimating a derivative of a summed input to said output node with respect to said first weight by:
multiplying a signal output by said first node by a value of a derivative of a transfer function of said second node that obtains when training data is applied to said neural network to obtain a first factor;
multiplying said first factor by said second weight to compute a first summand;
for each particular node of the plurality of additional nodes between said second node and said output node, computing an additional summand by multiplying together the first factor, a weight characterizing one of the first plurality of directed edges that couples the second node to the particular node, a weight characterizing one of the second plurality of directed edges that couples the particular node to the output node, and a value of a transfer function of the particular node; and
summing the first summand and the additional summands, wherein, in estimating said derivative, paths from said second node to said output node that involve said third plurality of directed edges are not considered.

14. The method of training the neural network according to claim 13 wherein comprising:
(a) applying training data to said neural network, whereby said summed input is generated at said output node;
(b) computing a value of a derivative of an objective function that depends on said derivative of said summed input to said output node with respect to said first weight;
(c) processing said derivative of said objective function with an optimization algorithm that uses derivative information; and
(d) repeating (a)-(c) until a stopping condition is satisfied.

15. The method of training the neural network according to claim 14 wherein said derivative of said objective function comprises:
using a nonlinear optimization algorithm selected from the group consisting of the steepest descent method, the conjugate gradient method, and the Broyden-Fletcher-Goldfarb-Shanno method.

16. The method of training the neural network work according to claim 14 wherein:
(a)-(b) are repeated for a plurality of training data sets, and an average of said derivatives of said objective function over said plurality of training data sets is used in (c).

17. The method of training the neural network according to claim 14 wherein:
after (d), setting weights that fall below a predetermined threshold to zero.

18. The method of training the neural network according to claim 17 wherein:
the objective function is a function of a difference an actual output of said neural network that depends on said summed input to said output node and an expected output; and
the objective function is a continuously differentiable function of a measure of near zero weights.

19. The method of training the neural network according to claim 18 wherein:
the measure of near zero weights takes the form:
$$U = {\sum }_{i = 1}^{K} {ⅇ}^{- η {w}_{i}^{2}}$$
where, Wᵢ is a an ith weight
K is a number of weights in the neural network;
η is a scale factor to which weights are compared.
